(19) United States
(12) Patent Application Publication
(10) Pub. No.: US 2009/0311423 A1
(43) Pub. Date: Dec. 17, 2009

(54) Surface-assisted combustion deposition deposited coatings, and/or methods of making the same

(75) Inventors: Desaraju V. Varaprasad, Ann Arbor, MI (US); Michael P. Remington, JR., Toledo, OH (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 12/213,008

(22) Filed: Jun. 12, 2008

(51) Int. Cl. B05D 1/00

(52) U.S. Cl. 427/223

(57) ABSTRACT

Certain example embodiments relate to surface-assisted combustion deposition deposited coatings (e.g., metal oxide coatings) formed on glass substrates, and/or methods of making the same. In certain example embodiments, a wet-applied (e.g., sol-gel applied) pre-treatment coating increases a number of nucleation sites on or proximate to the at least one surface of the substrate to be coated, and/or increases a number of binding sites or forms a binding medium on the at least one surface of the substrate to be coated. A combustion deposition deposited growth is formed thereon. The pre-treatment coating may facilitate the combustion deposition depositing of coatings.

### FIELD OF THE INVENTION

Certain example embodiments of this invention relate to the deposition of coatings onto substrates via combustion deposition. More particularly, certain example embodiments relate to surface-assisted combustion deposition deposited coatings (e.g., metal oxide coatings) formed on glass substrates, and/or methods of making the same. In certain example embodiments, a wet-applied pre-treatment coating increases a number of nucleation sites on or proximate to the at least one surface of the substrate to be coated, and/or increases a number of binding sites or forms a binding medium on the at least one surface of the substrate to be coated. The wet-applied pre-treatment coating may facilitate the combustion deposition depositing of coatings.

### BACKGROUND AND SUMMARY OF EXAMPLE EMBODIMENTS OF THE INVENTION

Combustion chemical vapor deposition (combustion CVD) is a relatively new technique for the growth of coatings. Combustion CVD is described, for example, in U.S. Pat. Nos. 5,652,021; 5,858,465; and 6,013,318, each of which is hereby incorporated herein by reference in its entirety. Generally, combustion deposition is an open atmosphere process that uses inexpensive precursors to produce thin films, thus facilitating deposition with high throughput at a low cost.

Conventionally, in combustion CVD, precursors are dissolved in a flammable solvent and the solution is delivered to the burner where it is ignited to give a flame. Such precursors may be vapor or liquid and fed to a self-sustaining flame or used as the fuel source. A substrate is then passed under the flame to deposit a coating.

There are several advantages of combustion CVD over traditional pyrolytic deposition techniques (such as CVD, spray and sol-gel, etc.). One advantage is that the energy required for the deposition is provided by the flame. A benefit of this feature is that the substrate typically does not need to be heated to temperatures required to activate the conversion of the precursor to the deposited material (e.g., a metal oxide). Also, a curing step (typically required for sol-gel techniques) typically is not required. Another advantage is that combustion CVD techniques do not necessarily require volatile precursors. If a solution of the precursor can be atomized/nebulized sufficiently (e.g., to produce droplets and/or particles of sufficiently small size), the atomized solution will behave essentially as a gas and can be transferred to the flame without requiring an appreciable vapor pressure from the precursor of interest.

It has been observed by the inventors of the instant application that some combustion deposition techniques work better with precursor materials that have a high vapor pressure, for example, by enabling the formation of more continuous and transparent coatings.

Moreover, the inventors of the instant application have realized that prior art approaches that have sought to deposit coatings on substrates whose surfaces are not particularly designed to promote film formation. However, the inventors have discovered that the choice of substrate and/or pre-coating of certain substrates can impact the formation of coatings to be supported thereon.

Thus, it will be appreciated that there is a need in the art for combustion deposition techniques that provide substrates that include wet-applied pre-treatments that promote the growth of films supported thereon.

In certain example embodiments of this invention, a method of forming a coating on a substrate is provided. A substrate having at least one surface to be coated is provided. A pre-treatment coating is wet applied to the substrate on the at least one surface to be coated. A precursor to be combusted is introduced. Using at least one flame, at least a portion of the precursor is combusted to form a combusted material, with the combusted material comprising non-vaporized material. The substrate is provided in an area so that the substrate is heated sufficiently to allow the combusted material to form the coating, directly or indirectly, on the substrate. The wet-applied pre-treatment coating increases a number of nucleation sites on or proximate to the at least one surface of the substrate to be coated, and/or increases a number of binding sites or forms a binding medium on the at least one surface of the substrate to be coated.

In certain example embodiments of this invention, a method of making a coated article comprising a coating supported by a substrate is provided. A substrate having at least one surface to be coated is provided. A pre-treatment coating is wet applied to the substrate on the at least one surface to be coated. A precursor to be combusted is introduced. Using at least one flame, at least a portion of the precursor is combusted to form a combusted material, with the combusted material comprising non-vaporized material. The substrate is provided in an area so that the substrate is heated sufficiently to allow the combusted material to form the coating, directly or indirectly, on the substrate. The wet-applied pre-treatment coating increases a number of nucleation sites on or proximate to the at least one surface of the substrate to be coated, and/or increases a number of binding sites or forms a binding medium on the at least one surface of the substrate to be coated.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a simplified view of an apparatus used to carry out combustion deposition in accordance with an example embodiment; and

FIG. 2 is an illustrative flowchart illustrating a process for wet applying a pre-treatment coating to a substrate and combustion deposition depositing a film thereon in accordance with an example embodiment.

### DETAILED DESCRIPTION OF EXAMPLE EMBODIMENTS OF THE INVENTION

In certain example embodiments of this invention, a method of forming a coating on a substrate is provided. A substrate having at least one surface to be coated is provided. A pre-treatment coating is wet applied to the substrate on the at least one surface to be coated. A precursor to be combusted is introduced. Using at least one flame, at least a portion of the precursor is combusted to form a combusted material, with the combusted material comprising non-vaporized material. The substrate is provided in an area so that the substrate is heated sufficiently to allow the combusted material to form the coating, directly or indirectly, on the substrate. The wet-applied pre-treatment coating increases a number of nucleation sites on or proximate to the at least one surface of the substrate to be coated, and/or increases a number of binding sites or forms a binding medium on the at least one surface of the substrate to be coated.

In certain example embodiments of this invention, a method of making a coated article comprising a coating supported by a substrate is provided. A substrate having at least one surface to be coated is provided. A pre-treatment coating is wet applied to the substrate on the at least one surface to be coated. A precursor to be combusted is introduced. Using at least one flame, at least a portion of the precursor is combusted to form a combusted material, with the combusted material comprising non-vaporized material. The substrate is provided in an area so that the substrate is heated sufficiently to allow the combusted material to form the coating, directly or indirectly, on the substrate. The wet-applied pre-treatment coating increases a number of nucleation sites on or proximate to the at least one surface of the substrate to be coated, and/or increases a number of binding sites or forms a binding medium on the at least one surface of the substrate to be coated.

It will be appreciated that combustion deposition techniques may be used to deposit metal oxide coatings (e.g., single-layer anti-reflective or SLAR coatings) on glass substrates, for example, to alter the optical and other properties of the glass substrates (e.g., to increase visible transmission). To this end, conventional combustion deposition techniques were used by the inventors of the instant application to deposit a single layer anti-reflective (SLAR) film of silicon oxide (e.g., SiO₂ or other suitable stoichiometry) on a glass substrate. The attempt sought to achieve an increase in light transmission in the visible spectrum (e.g., wavelengths of from about 400-700 nm) over clear float glass with an application of the film on one or both sides of a glass substrate. In addition, increases in light transmission for wavelengths greater the 700 nm are also achievable and also may be desirable for certain product applications, such as, for example, photovoltaic solar cells. The clear float glass used in connection with the description herein is a low-iron glass known as “Extra Clear,” which has a visible transmission typically in the range of 90.3% to about 91.0%. Of course, the examples described herein are not limited to this particular type of glass, or any glass with this particular visible transmission.

The combustion deposition development work was performed using a conventional linear burner. As is conventional, the linear burner was fueled by a premixed combustion gas comprising propane and air. It is, of course, possible to use other combustion gases such as, for example, natural gas, butane, etc. The standard operating window for the linear burner involves air flow rates of between about 150 and 300 standard liters per minute (SLM), using air-to-propane ratios of about 15 to 25. Successful coatings require controlling the burner-to-lite distance to between about 5-50 mm when a linear burner is used.

Typical process conditions for successful films used a burner air flow of about 225 SLM, an air-to-propane ratio of about 19, a burner-to-lite distance of 35 mm, and a glass substrate velocity of about 50 mm/sec.

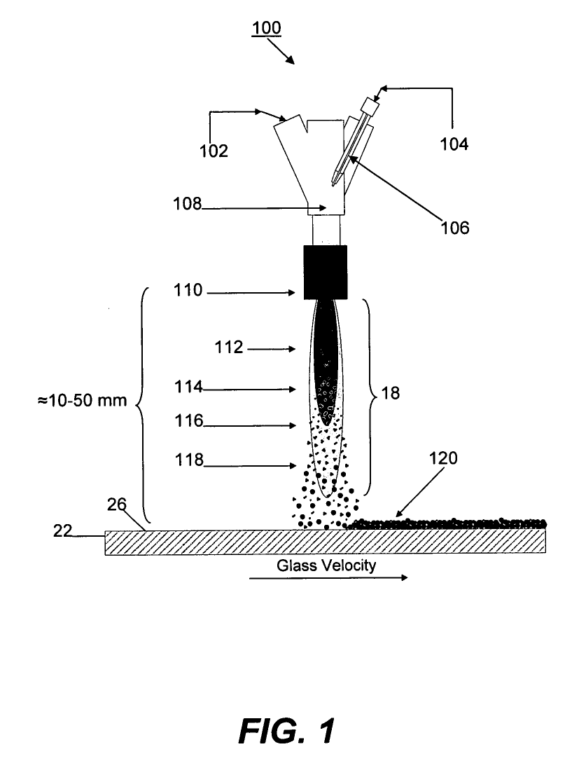

FIG. 1 is a simplified view of an apparatus 100 including a linear burner used to carry out combustion deposition. A combustion gas 102 (e.g., a propane air combustion gas) is fed into the apparatus 100, as is a suitable precursor 104 (e.g., via insertion mechanism 106, examples of which are discussed in greater detail below). Precursor nebulization (108) and at least partial precursor evaporation (110) occur within the apparatus 100 and also may occur external to the apparatus 100, as well. The precursor could also have been delivered as a vapor reducing or even eliminating the need for nebulization The flame 18 may be thought of as including multiple areas. Such areas correspond to chemical reaction area 112 (e.g., where reduction, oxidation, and/or the like may occur), nucleation area 114, coagulation area 116, and agglomeration area 118. Of course, it will be appreciated that such example areas are not discrete and that one or more of the above processes may begin, continue, and/or end throughout one or more of the other areas.

Particulate matter begins forming within the flame 18 and moves downward towards the surface 26 of the substrate 22 to be coated, resulting in film growth 120. As will be appreciated from FIG. 1, the combusted material comprises non-vaporized material (e.g., particulate matter), which is also at least partially in particulate form when coming into contact with the substrate 22. To deposit the coating, the substrate 22 may be moved (e.g., in the direction of the velocity vector). Of course, it will be appreciated that the present invention is not limited to any particular velocity vector, and that other example embodiments may involve the use of multiple apparatuses 100 for coating different portions of the substrate 22, may involve moving a single apparatus 100 while keeping the substrate in a fixed position, etc. The burner 110 is about 5-50 mm from the surface 26 of the substrate 22 to be coated.

Using the above techniques, the inventors of the instant application were able to produce coatings that provided a transmission gain of 1.96% or 1.96 percentage points over the visible spectrum when coated on a single side of clear float glass. The transmission gain may be attributable in part to some combination of surface roughness increases and air incorporation in the film that yields a lower effective index of refraction.

Although a percent change in Tᵥᵢₛ gain of about 2% is advantageous, further improvements are still possible. For example, optical modeling of these layers suggests that an index of refraction of about 1.33 for coatings that are about 100 nm thick should yield a transmission gain of about 3.0-3.5% or about 3.0-3.5 percentage points. The index of refraction of dense (e.g., no or substantially no air incorporation) silicon dioxide is nominally between about 1.45-1.5.

Certain example embodiments relate to combustion deposition techniques that provide substrates that are pre-treated and/or pre-conditioned to promote growth of the films that are supported thereon.

### Example Wet-Applied Pre-Treatment Coatings

A substrate may be pre-treated and/or pre-conditioned such that it includes a wet-applied coating. The wet-applied coating may be applied using conventional sol-gel or sol-gel like techniques. The application of a wet-applied pre-treatment is not conventional in combustion deposition techniques. This is particularly true for conventional combustion deposition techniques (unlike the techniques of certain example embodiments) that rely primarily on vapor depositions, since the general approach of such conventional processes relates to creating a vapor that itself forms a film on the substrate. Moreover, sol-gel and combustion deposition techniques generally are seen as competing and mutually exclusive routes to providing coatings on substrates. Thus, it will be appreciated that the example embodiments that use a sol-gel like coating process to wet-apply a pre-coating to a substrate that ultimately will have a combustion deposition deposited film formed thereon depart from this traditional paradigm in a surprising and unexpected manner also producing surprising and unexpected results.

Generally speaking, a sol-gel procedure for applying a wet pre-treatment coating may be carried out as follows in certain example embodiments. A “sol” is prepared, which includes a solution or suspension in water, alcohol and/or hydroalcoholic mixtures of precursor(s) of the element(s) whose oxide(s) is/are to be prepared. For instance, precursors may be alkoxides, of formula M(OR)ₙ, where M represents the element (e.g., Si) whose oxide is desired, the group —OR is the alkoxide moiety, and “n” represents the valence of M; soluble salt(s) of M such as chlorides, nitrates, and oxides may be used in place of alkoxides in certain example embodiments. During this phase, the precursor(s) may begin to hydrolyze (with or without an acid or base catalyst), e.g., alkoxide moieties or other anion bonded to the element M(s) may be replaced by —OH groups. Sol gelation may take from a few seconds to several days, depending on the chemical composition and temperature of the solution. During sol gelation, hydrolysis of the possibly remaining precursor(s) may be completed or substantially completed, and condensation may occur including reaction of —OH group(s) belonging to different molecules with formation of a free water molecule and an oxygen bridge between atoms M, M′ (which may be alike or different). The product obtained in this sol gelation phase may be called alcogel, hydrogel, xerogel, or the like, or more generally “gel” as is widely used to cover all such instances. Gel drying then occurs; in this phase, the solvent is removed by evaporation or through transformation into gas (e.g., via heating in certain instances), and a solid or dry body is obtained. Densification may be performed by heat treating or curing in certain example embodiments, whereby a porous gel densifies thereby obtaining a glassy or ceramic compact oxide.

### Increased Number of Nucleation Sites Examples

As noted above, in certain example embodiments, substrates that are pre-treated and/or pre-conditioned to promote the growth of films supported thereon are provided. The provision of a wet-applied pre-treatment coating may, in certain example embodiments, promote nucleation for the growth of thin films. Indeed, in certain example instances, the wet-applied pre-treatment coating may help to provide an increased number of nucleation sites on or close to the substrate, thereby potentially increasing the overall deposition rate. In certain example embodiments, crystalline formation also may occur during the combustion deposition depositing of the coating. For example, titanium inclusive coatings are known to be used in photocatalytic applications. In this regard, for example, the crystalline structure of titania is well suited for such photocatalytic applications. By providing a titania inclusive pre-coating on a substrate, e.g., via sol-gel or sol-gel like techniques, more nucleation sites may be formed on or proximate to the substrate. This arrangement advantageously may help to promote crystalline structure formations after the titania inclusive precursors are provided to the combustion deposition gas stream, which ultimately will form the majority of the coating supported by the substrate. Thus, it is possible to more easily achieve, and/or to better provide, a titanium inclusive metal oxide coating (e.g., TiO₂ or other suitable stoichiometry) supported by a substrate, e.g., by providing a titanium inclusive pre-coating to the substrate to promote the formation of nucleation sites on or proximate to the substrate prior to the combustion deposition depositing of the main film from a titanium oxide precursor.

Of course, it will be appreciated that the formation of a larger number of nucleation sites on or proximate to the substrate may be advantageous in the combustion deposition depositing of other metal oxide coatings in addition to, or in place of, titanium oxide coatings. Thus, it will be appreciated that other metal inclusive pre-treatments may be wet applied to the substrate and/or that other metal inclusive precursors may be provided to the combustion gas stream. Furthermore, the metal inclusive wet-applied pre-treatment and the metal inclusive precursor may comprise the same or different metals in certain example embodiments.

### Increased Number of Binding Sites/Binding Media Examples

In certain example embodiments, substrates are provided that are previously coated with low melting glass coating compositions that melt, soften, and/or liquefy during deposition processes. The melted, softened, and/or liquefied pre-coat may help act as a binding medium for particulate matter generated by the combustion deposition process. That is, certain example embodiments may provide pre-coatings that help act as a binder material in case the material that is to be grown into the ultimate film has a tendency to create powders, instead encouraging it to create a more continuous coating that may be more easily bound to the substrate. For example, silicon inclusive coatings are known to be used in single-layer anti-reflective (SLAR) coatings, and silicon oxide (e.g., SiO₂ or other suitable stoichiometry) coatings are useful in SLAR applications. By providing a silane inclusive pre-coating on a substrate, for example, via sol-gel or sol-gel like techniques, the formation of silica inclusive coatings may be facilitated, as the tendency for the silica to produce powders may be reduced by providing more binding sites or a binding medium for the particles. This arrangement may help to promote the formation of more continuous film growths when the silica inclusive precursors that ultimately will form the majority of the coating supported by the substrate are provided to the combustion deposition gas stream. Thus, it is possible to more easily achieve, and/or to better provide, a silicon inclusive metal oxide coating (e.g., SiO₂ or other suitable stoichiometry) supported by a substrate, e.g., by providing a silicon inclusive pre-coating to the substrate to promote the formation of binding sites or a binding medium on the substrate prior to the combustion deposition depositing of the main film from a silicon oxide precursor. Furthermore, the metal oxide coating may be more continuous (for example, it may be substantially continuous) when compared to prior art techniques that sometimes produce powders rather than, or in addition to, coatings.

In certain example instances, the sol-gel formulations may include, for example, a wet/liquid mixture of: (a) silane precursor, (b) alcohol, (c) water, and (d) acid(s) or base(s). For purposes of example, a silane or silica precursor may be TEOS (Tetraethylorthosilicate), TMOS (Tetramethylorthosilicate), glycidoxypropyl-tyimethoxysilane (GLYMO), or the like in certain example embodiments, and the alcohol may be ethanol and/or isopropanol in certain example embodiments, although other silanes and alcohols may instead be used. An example acid is nitric or hydrochloric acid, although other acid(s) may instead be used. This mixture of (a)-(d) may make up the sol-gel coating in certain example embodiments. The sol-gel formulations may be applied on the substrate via curtain coating, spray coating, roll coating, or in any other suitable manner.

The sol-gel coating may be heat treated or cured following its application to the substrate. In such example instances, the sol-gel coating may be heated (e.g., from about 200 to 1,000° C., more preferably from about 200-800° C., and even more preferably from about 300-600° C.) to drive off certain liquid(s) of the sol-gel (e.g., the water and acid) so that the silica precursor (e.g., TEOS) turns into a solid silica based network whereby the coating densifies and forms a solid coating. In certain example embodiments, the resulting wet-applied coating may be of or include silica (SiO₂ or other suitable stoichiometry) or the like.

The resulting wet-applied coating may be made up of at least about 75% silicon oxide (SiO₂ or other suitable stoichiometry), more preferably at least about 80%, and most preferably at least about 85%, in certain example embodiments of this invention.

Of course, it will be appreciated that the formation of a larger number of binding sites or a binding medium on the substrate and/or the formation of more continuous coatings may be advantageous in the combustion deposition depositing of other metal oxide coatings in addition to, or in place of, silicon oxide coatings. Thus, it will be appreciated that other metal inclusive pre-coatings may be applied to the substrate and/or that other metal inclusive precursors may be provided to the combustion gas stream. Furthermore, the metal inclusive pre-coating and the metal inclusive precursor may comprise the same or different metals in certain example embodiments.

### Increased Number of Nucleation and Binding Sites/Binding Media Examples

Furthermore, certain example embodiments also provide coatings on glass substrates that act both as nucleating sites and as binding media for combustion deposition coating materials. Such properties may be useful when depositing multi-layer anti-reflective (MLAR) coatings, for example, that include a high refractive index film provided closest to the substrate followed by a low refractive index film provided farther from the substrate. In certain example instances, it may be advantageous to provide an MLAR coating by growing a high refractive index titanium or silicon-titanium inclusive film closest to the substrate, followed by a low refractive index silicon inclusive film. Combustion deposition techniques are well suited for deposited low-index silica coatings. However, other techniques may provide titania and/or silica-titania inclusive coatings more easily and/or with better results when compared to conventional combustion deposition techniques. Thus, a titanium inclusive (e.g., titania inclusive) coating may be wet applied to the substrate, and a silicon inclusive film may be combustion deposition deposited thereon. Furthermore, a silica-titania inclusive film may be formed on the substrate directly in certain example embodiments. However, in certain other example embodiments, a titania inclusive film may be formed via the wet application process and the introduction of silica from the combustion deposition may, in addition to forming the silicon inclusive film, also help provide a silica-titania coating underneath the silicon inclusive film. Thus, it is possible to provide in certain example embodiments pre-treatments to substrates that help form nucleating sites, provide binding sites and/or binding media for combustion deposition deposited coatings, and/or promote more continuous growths. Thus, it will be appreciated that, in a broad sense, the increased nucleation site examples and the increased binding sites/media examples described herein may be combined to achieve yet further example embodiments.

### Other Pre-Treatment Examples

By changing the combustion deposition feed composition, as well as the impinging velocity of the combustion deposition coating media, the bulk properties and/or surface characteristics of low melting glass pre-treatment compositions may be altered to impart desired optical properties to substrates. In certain example instances, it may be possible to increase the mechanical durability of certain coatings, e.g., via the application of a wet-applied pre-coating. For example, an alkali barrier coating may be provided via wet application. Additionally, or in the alternative, it may be possible to heat treat and/or temper the wet-applied coating, before and/or after the combustion deposition deposited coating is formed on the substrate. It follows, then, that the heat treatment may be applied to both the wet-applied pre-treatment coating and the combustion deposition deposited coating together. It will be appreciated that the heat treatment of the wet-applied pre-treatment coating and the combustion deposition deposited coating, separately or together, may influence the properties of one or both of these coatings.

Surface assisted combustion deposition techniques may be used, for example, to produce transparent and/or translucent coatings of high, medium, or low index materials. Such coatings may be used in a variety of applications including, for example, anti-glare coatings, anti-reflective coatings, photocatalytic coatings, hydrophilic coatings, etc.

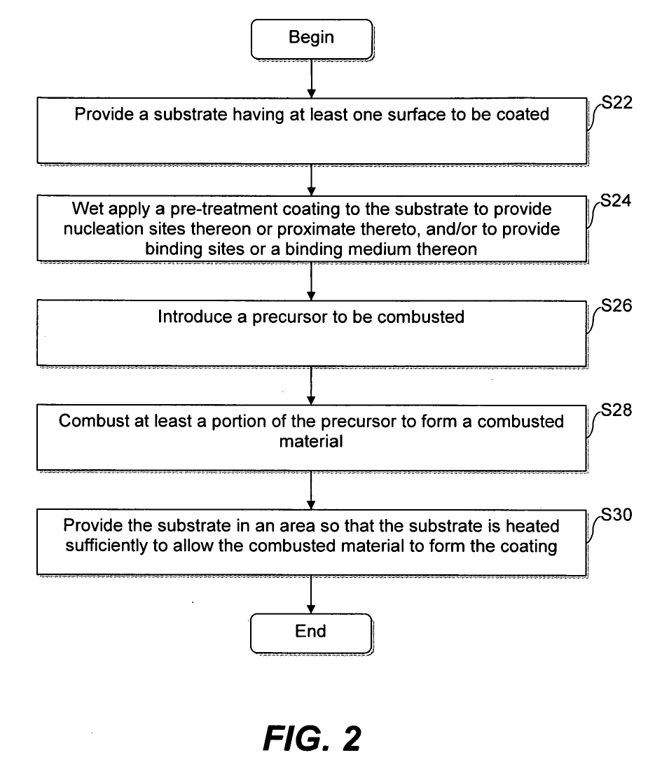

FIG. 2 is an illustrative flowchart illustrating a process for wet applying a pre-treatment coating to a substrate and combustion deposition depositing a film thereon in accordance with an example embodiment. In step S22, a substrate (e.g., a glass substrate) having at least one surface to be coated is provided. A wet-applied pre-treatment coating is provided to the substrate. This wet-applied pre-treatment coating may help to provide nucleation sites on or proximate to the substrate, and/or may help to provide binding sites or binding media thereon. In certain example embodiments, the wet pre-treatment coating may be applied as a sol-gel. A precursor to be combusted is introduced in step S26. In step S28, at least a portion of the precursor is combusted, thereby forming a combusted material. The precursor may be introduced by a number of means. For example, the precursor may be introduced in a vapor state via a bubbler or other means of vaporization or sublimation, as large particle droplets via an injector, and/or as small particle droplets via a nebulizer. Additionally, in certain example embodiments, the wet-applied pre-treatment coating also may help to form a more continuous coating, e.g., by reducing the amount of loose powder formed on the substrate by the combusting of the precursor. The combusted material comprises non-vaporized material (e.g., at least some particulate matter). In step S30, the substrate is provided in an area so that the substrate is heated sufficiently to allow the combusted material to form the coating on the substrate. The coating may be formed either directly or indirectly on the substrate.

Optionally, in a step not shown, the opposing surface of the substrate also may be provided a wet-applied pre-treatment coating and/or coated via combustion deposition (e.g., using a two-pass configuration). Also optionally, the substrate may be wiped and/or washed, e.g., to remove excess non-adherent particulate matter deposited thereon. In certain example embodiments, metal oxide films may be produced. Thus, a metal oxide pre-treatment coating may be wet applied to the substrate, and/or a metal oxide coating may be formed on the substrate via combustion deposition. The metal oxides applied in the wet application and via combustion deposition processes may be the same or different metal oxides in certain example embodiments.

It will be appreciated that the techniques described herein can be applied to a variety of metal oxides, and that the present invention is not limited to any particular type of metal oxide deposition and/or precursor. For example, oxides of the transition metals and lanthanides such as, for example, Y, Ti, Zr, Hf, V, Nb, Ta, Cr, Mo, W, La, Ce, Cr, Mo, W, Mn, Fe, Ru, Co, Ir, Ni, Cu, and main group metals and metalloids such as, for example, Zn, Cd, B, Al, Ga, In, Si, Ge, Sn, Sb and Bi, and mixtures thereof can all be deposited using the techniques of certain example embodiments.

It will be appreciated that the foregoing list is provided by way of example. For example, the metal oxides identified above are provided by way of example. Any suitable stoichiometry similar to the metal oxides identified above may be produced. Additionally, other metal oxides may be deposited, other precursors may be used in connection with these and/or other metal oxide depositions, the precursor delivery techniques may be altered, and/or that other potential uses of such coatings may be possible. Still further, the same or different precursors may be used to deposit the same or different metal oxides.

Also, it will be appreciated that the techniques of the example embodiments described herein may be applied to a variety of products. That is, a variety of products potentially may use these and/or other AR films, depending in part on the level of transmission gain that is obtained. Such potential products include, for example, photovoltaic, green house, sports and roadway lighting, fireplace and oven doors, picture frame glass, etc. Non-AR products also may be produced.

The example embodiments described herein may be used in connection with other types of multiple layer AR coatings, as well. By way of example and without limitation, multiple reagents and/or precursors may be selected to provide coatings comprising multiple layers.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of forming a coating on a substrate, the method comprising:
providing a substrate having at least one surface to be coated;
wet applying a pre-treatment coating to the substrate on the at least one surface to be coated;
introducing a precursor to be combusted;
combusting, using at least one flame, at least a portion of the precursor to form a combusted material, the combusted material comprising non-vaporized material; and
providing the substrate in an area so that the substrate is heated sufficiently to allow the combusted material to form the coating, directly or indirectly, on the substrate.

2. The method of claim 1, further comprising wet applying the pre-treatment coating as a sol-gel coating.

3. The method of claim 1, wherein the wet-applied pre-treatment coating increases a number of nucleation sites on or proximate to the at least one surface of the substrate to be coated, and/or increases a number of binding sites or forms a binding medium on the at least one surface of the substrate to be coated.

4. The method of claim 1, further comprising forming a substantially continuous coating by reducing an amount of loose powder formed on the substrate by the combusting of the precursor.

5. The method of claim 4, further comprising providing a silane inclusive pre-treatment coating in forming a silicon oxide coating on the substrate.

6. The method of claim 1, further comprising increasing the number of binding sites by melting, softening, and/or liquefying the pre-treatment coating during the combusting of the precursor.

7. The method of claim 1, further comprising providing a titania inclusive pre-treatment coating in forming a titanium oxide coating on the substrate.

8. The method of claim 3, wherein the wet application of the pre-treatment coating increases the number of nucleation sites on or proximate to the at least one surface of the substrate to be coated, and increases the number of binding sites or forms a binding medium on the at least one surface of the substrate to be coated in providing a multi-layer anti-reflective (MLAR) coating.

9. The method of claim 8, further comprising:
providing a high refractive index film on the at least one surface of the substrate to be coated via the wet application of the pre-treatment coating; and
combustion deposition depositing a low refractive index film supported by the high refractive index film farther from the substrate.

10. The method of claim 9, wherein the high refractive index film is a titanium or silicon-titanium inclusive film, and wherein the low refractive index film is a silicon inclusive film.

11. The method of claim 1, further comprising increasing mechanical durability of the coating via the inclusion of the wet-applied pre-treatment coating.

12. The method of claim 1, further comprising wet applying a pre-treatment coating and a combustion deposition deposited coating to opposing surfaces of the substrate.

13. A method of making a coated article comprising a coating supported by a substrate, the method comprising:
providing a substrate having at least one surface to be coated;
wet applying a pre-treatment coating to the substrate on the at least one surface to be coated;
introducing a precursor to be combusted;
combusting, using at least one flame, at least a portion of the precursor to form a combusted material, the combusted material comprising non-vaporized material; and
providing the substrate in an area so that the substrate is heated sufficiently to allow the combusted material to form the coating, directly or indirectly, on the substrate.

14. The method of claim 13, further comprising wet applying the pre-treatment coating as a sol-gel coating.

15. The method of claim 13, wherein the wet-applied pre-treatment coating increases a number of nucleation sites on or proximate to the at least one surface of the substrate to be coated, and/or increases a number of binding sites or forms a binding medium on the at least one surface of the substrate to be coated.

16. The method of claim 13, further comprising forming a substantially continuous coating by reducing an amount of loose powder formed on the substrate by the combusting of the precursor.

17. The method of claim 13, further comprising increasing the number of binding sites or forming a binding medium by melting, softening, and/or liquefying the pre-treatment coating during the combusting of the precursor.

18. The method of claim 15, wherein the wet application of the pre-treatment coating increases the number of nucleation sites on or proximate to the at least one surface of the substrate to be coated, and increases the number of binding sites or forms the binding medium on the at least one surface of the substrate to be coated in providing a multi-layer anti-reflective (MLAR) coating.

19. The method of claim 18, further comprising:
providing a high refractive index film on the at least one surface of the substrate to be coated via the wet application of the pre-treatment coating; and
combustion deposition depositing a low refractive index film supported by the high refractive index film farther from the substrate.

20. The method of claim 13, further comprising increasing mechanical durability of the coating via the inclusion of the wet-applied pre-treatment coating.
